(19) United States
(12) Patent Application Publication
(10) Pub. No.: US 2013/0107495 A1
(43) Pub. Date: May 2, 2013

(54) WASHING MACHINE

(71) Applicant: SAMSUNG ELECTRONICS CO., LTD., Suwon (KR)

(72) Inventor: Jong Won PARK, Seongnam (KR)

(73) Assignee: SAMSUNG ELECTRONICS CO., LTD., Suwon (KR)

(21) Appl. No.: 13/660,551

(22) Filed: Oct. 25, 2012

(30) Foreign Application Priority Data
Nov. 2, 2011 (KR) 10-2011-0113224

(51) Int. Cl. F21V 33/00

(52) U.S. Cl. 362/23.13

(57) ABSTRACT

A washing machine having a graphic display configured to reduce material cost and manufacturing time by changing the material of a light diffuser, and to reuse the component other than the component having a defect, by improving an assembly structure thereof, in which the washing machine having a graphic display to display an option selected by a user through light emitted from a plurality of light emitting diodes (LED) includes a printed circuit board (PCB) on which the plurality of LEDs are assembled, a LED housing to form an exterior while coupled to the PCB, and configured to block the light emitted from the plurality of LEDs, a light diffuser coupled to the LED housing, and formed with transparent plastic to diffuse the light emitted from the plurality of LEDs, and a display film attached to the light diffuser to block the light emitted from the plurality of LEDs.

### CROSS-REFERENCE TO RELATED APPLICATIONS

This application claims the priority benefit of Korean Patent Application No. 10-2011-0113224, filed on Nov. 2, 2011 in the Korean Intellectual Property Office, the disclosure of which is incorporated herein by reference.

### BACKGROUND

1. Field

The following description relates to a washing machine having a graphic display.

2. Description of the Related Art

In general, a graphic display, which is being used at various electronic products such as a washing machine and a drying machine, is an apparatus configured to display various options that is selected by a user through a light emitted from a light emitting diode (LED).

For the graphic display, a light diffuser is used to diffuse the light emitted from the LED so that the light is not directly seen by a user.

The light diffuser being used at the graphic display is structured by assembling a LED board on a LED housing, and then by applying epoxy resin in between the LED board and the LED housing and by hardening the epoxy resin to fix the LED board to the LED housing.

Since the light diffuser is manufactured with epoxy resin, the cost of the raw material of the epoxy resin is high, and a hardening process is needed to harden the epoxy resin, and thus, additional cost is occurred.

In addition, the LED board includes a printed circuit board (PCB), a LED, and a control device, and thus, the cost of the LED board is high.

In the process of manufacturing the graphic display, first, after assembling the LED board on the LED housing, epoxy resin is applied in between the LED housing and the LED board, and is hardened.

As the epoxy resin is hardened, the epoxy resin is used as the light diffuser that diffuses the light emitted from the LED mounted on the LED board.

As the epoxy resin is hardened and fixed, by attaching a display film to the LED housing and by solder-coupling the LED housing, which is provided with the LED board and the light diffuser fixed thereto, to a PCB, the graphic display is manufactured.

However, when a defect is occurred during the manufacturing of the graphic display, for example, by the application of the epoxy resin and the solder finish, a reusing of the graphic display is not possible, and the product is discarded as a whole.

Thus, there is a need for a graphic display capable of having a reduced material cost by changing the different material for a diffuser and capable of enabling components having no defect to be reused in a case when a defect is occurred by improving the assembly structure.

### SUMMARY

Therefore, it is an aspect of the present disclosure to provide a washing machine having a graphic display configured to reduce material cost and manufacturing time by changing the material of a light diffuser thereof.

In addition, it is another aspect of the present disclosure to provide a washing machine having a graphic display configured to reuse the component other than the component having a defect, even in a case when a defect is occurred, by improving an assembly structure thereof.

Additional aspects of the disclosure will be set forth in part in the description which follows and, in part, will be obvious from the description, or may be learned by practice of the disclosure.

In accordance with an aspect of the present disclosure, a washing machine having a graphic display to display an option selected by a user through light emitted from a plurality of light emitting diodes (LED) includes a printed circuit board, a LED housing, a light diffuse, and a display film. The PCB has the plurality of LEDs assembled thereon. The LED housing may form an exterior while coupled to the PCB while being configured to block the light emitted from the plurality of LEDs. The light diffuser may be coupled to the LED housing, and formed with transparent plastic to diffuse the light emitted from the plurality of LEDs. The display film may be attached to the light diffuser to block the light emitted from the plurality of LEDs.

The washing machine may further include a LED guide provided with a plurality of LED guide portions formed thereto to guide the plurality of LEDs to maintain a precise position, and configured to block the light emitted from the plurality of LEDs.

A first hook may be formed at the LED guide, and a first coupling groove may be formed on the PCB at a position corresponding to a position of the first hook, such that the first hook is coupled to the first coupling groove, and thereby the LED guide is coupled to the PCB.

A first projection each is formed on a left side surface and a right side surface of an inside the LED housing, such that the LED guide is coupled to the LED housing in a forcedly fitted manner.

The LED guide may be integrally formed with the LED housing.

A second hook may be formed at the LED housing, and a second coupling groove may be formed on the PCB at a position corresponding to a position of the second hook, such that the second hook is coupled to the second coupling groove, and thereby the LED housing is coupled to the PCB.

The LED housing may include a plurality of LED accommodating portions to accommodate the plurality of LEDs.

The light diffuser may include a plurality of protrusion portions formed at positions corresponding to the plurality of LED accommodating portions, and may be formed in an integral shape to cover a front surface of the LED housing.

A third hook may be formed at the light diffuser, and a third coupling groove may be formed on the LED housing at a position corresponding to a position of the third hook, such that the third hook is coupled to the third coupling groove, and thereby the light diffuser is coupled to the LED housing.

A second projection may be formed at an inside of the plurality of the LED accommodating portions, such that the plurality of protrusion portions is coupled to the second projection formed at an inside of the plurality of the LED accommodating portions in a forcedly fitted manner, and thereby the light diffuser is coupled to the LED housing.

The light diffuser may include a plurality of protrusion portions formed at positions corresponding to the plurality of LED accommodating portions, and each of the plurality of protrusion portions is formed independently to each other

An upper surface or a lower surface of the light diffuser may be subject to a corrosion treatment or added with a texture shape to effectively diffuse the light emitted from the plurality of LEDs.

The light diffuser may include semi-transparent material such as semi-transparent plastic.

The display film may be inserted formed into the light diffuser.

In according to another aspect of the present disclosure, a washing machine having a graphic display to display an option selected by a user through light emitted from a plurality of light emitting diodes (LED) includes a printed circuit board (PCB), an LED guide, a LED housing, a light diffuser, and a display film. The PCB has the plurality of LEDs assembled thereon. The LED guide may be configured to guide the plurality of LED to maintain a precise position, and to block the light emitted from the plurality of LEDs. The LED housing may be configured to accommodate the plurality of LEDs while blocking the light emitted from the plurality of LEDs. The light diffuser may be formed with transparent material such as transparent plastic or semi-transparent material such as semi-transparent plastic to diffuse the light emitted from the plurality of LEDs. The display film may be attached to the light diffuser to block the light emitted from the plurality of LEDs. A second hook may be formed at the LED housing, and a second coupling groove may be formed on the PCB at a position corresponding to a position of the second hook, such that the second hook is coupled to the second coupling groove, and thereby the LED housing is coupled to the PCB.

The LED guide may include a plurality of LED guide portions to guide the plurality of LEDs to maintain a precise position.

A first hook may be formed at the LED guide, and a first coupling groove may be formed on the PCB at a position corresponding to a position of the first hook, such that the first hook is coupled to the first coupling groove, and thereby the LED guide is coupled to the PCB.

A first projection may be formed at a left side surface and a right side surface of an inside of the LED housing, such that the LED guide is coupled to the LED housing in a forcedly fitted manner.

The LED guide may be integrally formed with the LED housing.

The LED housing may include a plurality of LED accommodating portions to accommodate the plurality of LEDs.

The light diffuser may include a plurality of protrusion portions formed at positions corresponding to the plurality of LED accommodating portions, and may be formed in an integral shape to cover a front surface of the LED housing.

A third hook may be formed at the light diffuser, and a third coupling groove may be formed on the LED housing at a position corresponding to a position of the third hook, such that the third hook is coupled to the third coupling groove, and thereby the light diffuser is coupled to the LED housing.

A second projection is formed at an inside the LED accommodating portions, such that the plurality of protrusion portions is coupled to the second projection, which is formed at an inside the plurality of the LED accommodating portions, in a forcedly fitted manner, and thereby the light diffuser is coupled to the LED housing.

The light diffuser may include a plurality of protrusion portions formed at positions corresponding to the plurality of LED accommodating portions, and each of the plurality of protrusion portions is formed independently to each other.

An upper surface or a lower surface of the light diffuser may be subject to a corrosion treatment, or may be added with a texture shape to effectively diffuse the light emitted from the plurality of LEDs.

The display film may be insertedly formed into the light diffuser.

As described above, by using a transparent or a semi-transparent material such as transparent or a semi-transparent plastic, not epoxy resin, as a light diffuser, the material cost may be reduced.

In addition, by improving the assembly structure, in a case of when a defect is occurred at some of the components, the components other than the components having a defect may be reused.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a cross-sectional view of a washing machine in accordance with an embodiment of the present disclosure.

FIG. 2 is a perspective view of a washing machine in accordance with an embodiment of the present disclosure.

FIG. 3 is an exploded perspective view of a graphic display in accordance with an embodiment of the present disclosure.

FIG. 4 is an exploded perspective view showing an alternative coupling structure of a LED housing and a LED guide of a graphic display in accordance with an embodiment of the present disclosure.

FIG. 5 is an exploded perspective view showing an LED housing integrally formed with a LED guide in a graphic display in accordance with an embodiment of the present disclosure.

FIG. 6 is an exploded perspective view showing an alternative coupling structure of a LED housing and a light diffuser of a graphic display in accordance with an embodiment of the present disclosure.

FIG. 7 is a drawing showing an alternative example of a light diffuser of a graphic display in accordance with an embodiment of the present disclosure.

FIG. 8 is an exploded perspective view showing a display film inserted into a light diffuser of a graphic display in accordance with an embodiment of the present disclosure.

### DETAILED DESCRIPTION

Reference will now be made in detail to embodiments of the present disclosure, examples of which are illustrated in the accompanying drawings, wherein like reference numerals refer to like elements throughout.

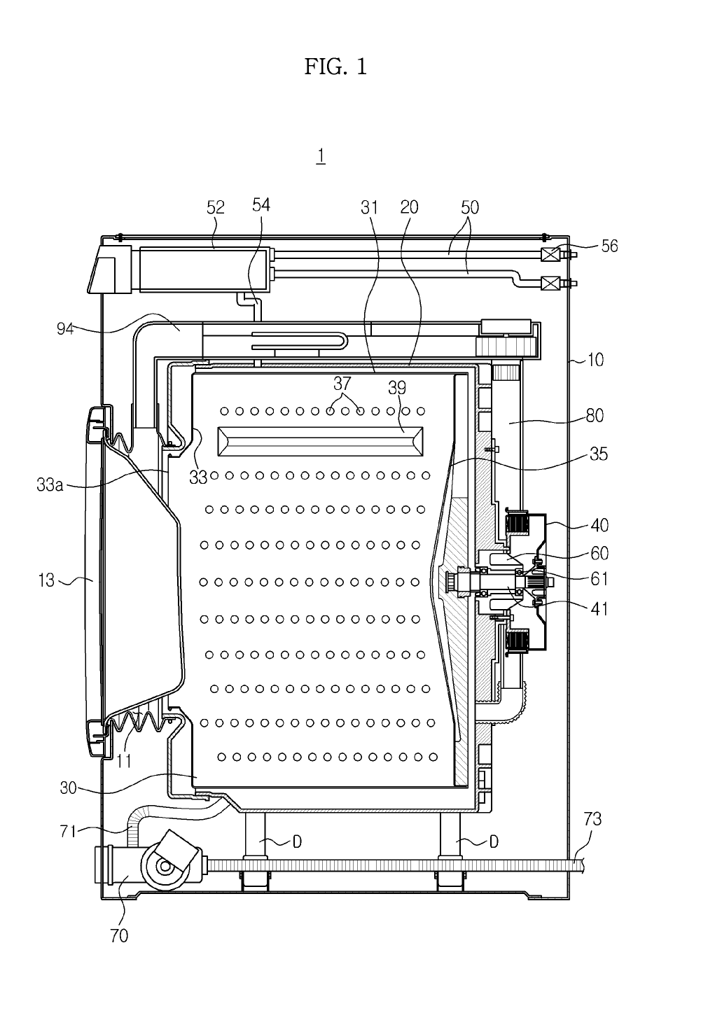

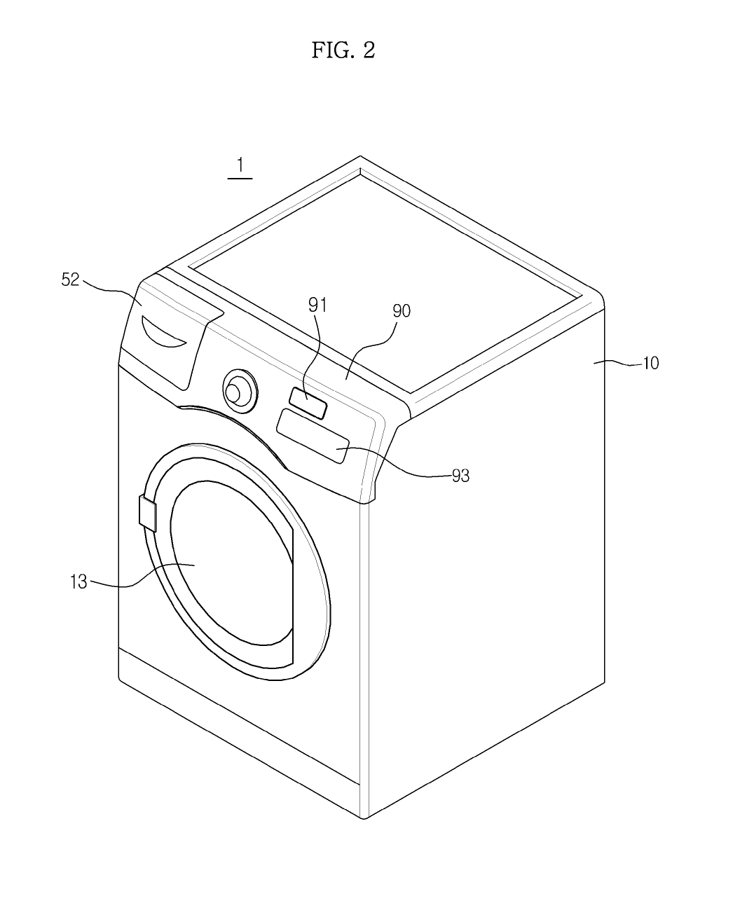

As illustrated on FIGS. 1 to 2, a washing machine 1 includes a cabinet 10 forming an exterior, a tub 20 disposed at an inside the cabinet 10, a drum 30 rotatively disposed at an inside the tub 20, and a motor 40 to drive the drum 30.

An input portion 11 is formed at a front of the cabinet 10 to input a laundry to an inside the drum 30, and the input portion 11 is open/closed by a door 13 installed at a front surface portion of the cabinet 10.

A water supply pipe 50 is installed at an upper portion of the tub 20 to supply washing water to the tub 20. One side of the water supply pipe 50 is connected to a water supply valve 56, and the other side of the water supply pipe 50 is connected to a detergent container 52.

The detergent container 52 is connected to the tub 20 through a connecting pipe 54. The water supplied through the water supply pipe 50 passes through the detergent container 52, and is supplied to an inside the tub 20 along with detergent.

The tub 20 is supported by a damper D. The damper D connects a lower surface of an inner side of the cabinet 10 to an outer surface of the tub 20.

The tub 30 includes a cylindrical portion 31, a front surface panel 33 disposed at a front of the cylindrical portion 31, and a rear surface panel 35 disposed at a rear of the cylindrical portion 31.

An opening hole 33a is formed at the front surface panel 33 for the entry/exit of the laundry, and a driving shaft 41 is connected to the rear surface panel 35 to deliver the driving force of the motor 40.

A plurality of penetrating holes 37 are provided at a circumference of the drum 30 for circulation of the washing water, and a plurality of lifters 39 are installed at an inner circumferential surface of the drum 30, such that the laundry ascends and descends as the tub 30 rotates.

The driving shaft 41 is disposed in between the drum 30 and the motor 40. One end of the driving shaft 41 is connected to the rear surface panel 35 of the tub 20, and the other end of the driving shaft 41 is extended to an outer side of a rear wall of the tub 20.

As the motor 40 rotates the driving shaft 41, the drum 30 connected to the driving shaft 41 is rotated on the driving shaft 41.

A bearing housing 60 is installed at the rear wall of the tub 20 to rotatively support the driving shaft 41.

The bearing housing 60 may be formed with an aluminum alloy, and may be inserted into the rear wall of the tub 20 when the tub 20 is injection-molded.

A plurality of bearings 61 are installed in between the bearing housing 60 and the driving shaft 41, such that the driving shaft 41 may be smoothly rotated.

A drain pump 70 to discharge the water inside the tub 20 to an outside the cabinet 10, a connecting hose 71 to connect the tub 20 to the drain pump 70 such that the water inside the tub 20 is introduced to the drain pump 70, and a drain hose 73 to guide the water pumped by the drain pump 70 to an outside the cabinet 10 are provided at a lower side of the tub 20.

A drying apparatus 80 may be mounted at the tub 20 to dry the air at an inside the tub 20 and then to resupply the dried air to an inside the tub 20.

The cabinet 10 is provided at an upper portion of the front surface thereof with a control panel 90 including a display portion 91, which is to be described later, configured to transmit the light emitted from a graphic display 100 so that a user may check the light, and an operating portion 93 enabling a user to select an option to control the operation of the washing machine 1.

The graphic display 100 is provided at a rear surface of the control panel 90 to display the option, which is selected by a user to control the operation of the washing machine 1, through the light emitted from a plurality of LEDs L.

The graphic display 100 may be used at various electronic products such as a drying machine, other than at the washing machine 1.

Hereinafter, a graphic display configured to reduce material cost and manufacturing time by changing the material of a light diffuser and to reuse the component other than the component having a defect, even in a case when a defect is occurred, by improving an assembly structure will be described in detail.

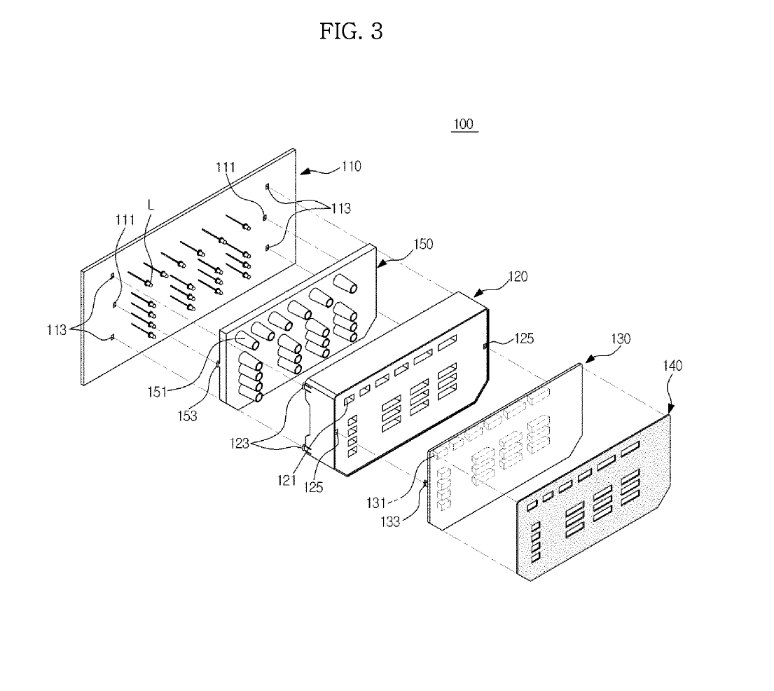

Referring to FIG. 3, the graphic display 100 includes a printed circuit board 110 on which a plurality of LEDs L are assembled, a LED guide 150 to guide the plurality of LEDs L to maintain a precise position and to block the light emitted from the plurality of LEDs L, a LED housing 120 coupled to the PCB 110 while blocking the light emitted from the plurality of LEDs L, a light diffuser 130 to diffuse the light emitted from the plurality of LEDs L, and a display film 140 attached to the light diffuser 130 and to block the light emitted from the plurality of LEDs L.

The plurality of LEDs L are directly assembled to the PCB 110. The PCB 110 is provided with a first coupling groove 111 and a second coupling groove 113 which are coupled to a first hook 153 formed at the LED guide 150 and a second hook 123 formed at the LED housing 120, respectively, the first hook 153 and the second hook 123 to be described later.

Since a LED board constructed to have LEDs and a control device assembled thereto is omitted, and the plurality of LEDs L are directly assembled to the PCB board 110, the structure becomes simpler, and thus, the manufacturing cost may be reduced.

The first coupling groove 111 is formed on the PCB 110 at a position corresponding to a position of the first hook 153 formed on the LED guide 150, so that the first coupling groove 111 is coupled to the first hook 153, and thus, the LED guide 150 is coupled to the PCB 110.

In FIG. 3, it is illustrated that the PCB 110 is provided at each of the left/right sides thereof with one unit of the first coupling groove 111 to correspond to the number of the first hook 153 formed on the LED guide 150, but without being limited to such, the first coupling groove 111 may be variously formed according to the number and the position of the first hook 153 formed at the LED guide 150.

The second coupling groove 113 is formed on the PCB 110 at a position corresponding to a position of the second hook 123 formed on the LED housing 120, so that the second coupling groove 113 is coupled to the second hook 123, the LED housing 120 is coupled to the PCB board 110.

In FIG. 3, it is illustrated that the PCB 110 is provided at each of the left/right sides thereof with two units of the second coupling groove 113 to correspond to the number of the second hook 123 formed on the LED housing 120, but without being limited to such, the second coupling groove 113 may be variously formed according to the number and the position of the second hook 123 formed at the LED housing 120.

The LED guide 150 is coupled to the PCB 110 and to block the light emitted from the plurality of LEDs L.

The LED guide 150 includes a plurality of LED guide portions 151 to guide the plurality of LEDs L, which are directly assembled on the PCB 110, to maintain a precise position, and the first hook 153 for the coupling to the PCB 110. The LED guide portions may be cylindrical or cone shape with open ends so that the LEDs L maybe inserted thereto.

As the first hook 153 formed at the LED guide 150 is coupled to the first coupling groove 111 formed on the PCB 110, the LED guide 150 is coupled to the PCB board 110.

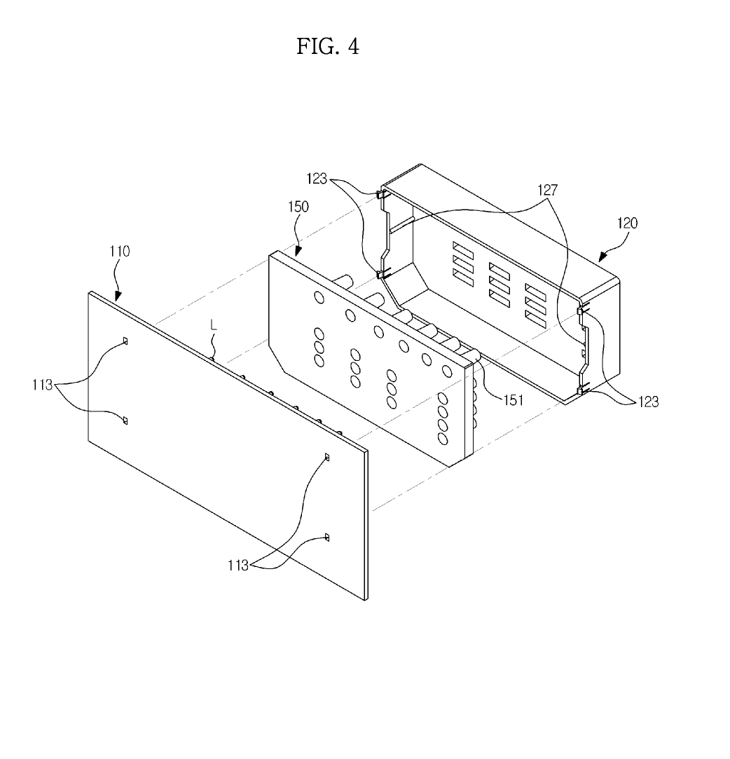

Referring to FIG. 4, the LED guide 150 may be structured in a way that the LED guide 150 is not being directly assembled to the PCB 110, but is coupled to the PCB 110 along with the LED housing 120 after being coupled to the LED housing 120.

When coupling the LED guide 150 to the LED housing 120, one unit of a first projection 127 is formed on each of the left/right side of an inside the LED housing 120, such that the LED guide 150 is coupled to the LED housing 120 in a forcedly fitted manner.

In FIG. 4, it is illustrated that the LED housing 120 is provide at each of the left/right sides of inside thereof with one unit of the first projection 127, but without being limited as such, the position and the number of the first projection 127 formed at an inside the LED housing 120 may be variously adjusted. For example, the first projection may be formed on the top/bottom side of the inside the LED housing 120 or diagonally formed thereof.

In this case, since the LED guide 150 is not directly coupled to the PCB 110, the first hook 153 formed at the LED guide 150 is omitted, and to correspond to the position and the number of the first hook 153, the first coupling groove 111 formed on the PCB 110 is also omitted.

After the LED guide 150 is coupled to the LED housing 120, as shown in FIG. 3 or FIG. 4, the second hook 123 formed at the LED housing 120 is coupled to the second coupling groove 113 formed on the PCB 110, and thus, the LED guide 150 and the LED housing 120 are coupled to the PCB 110.

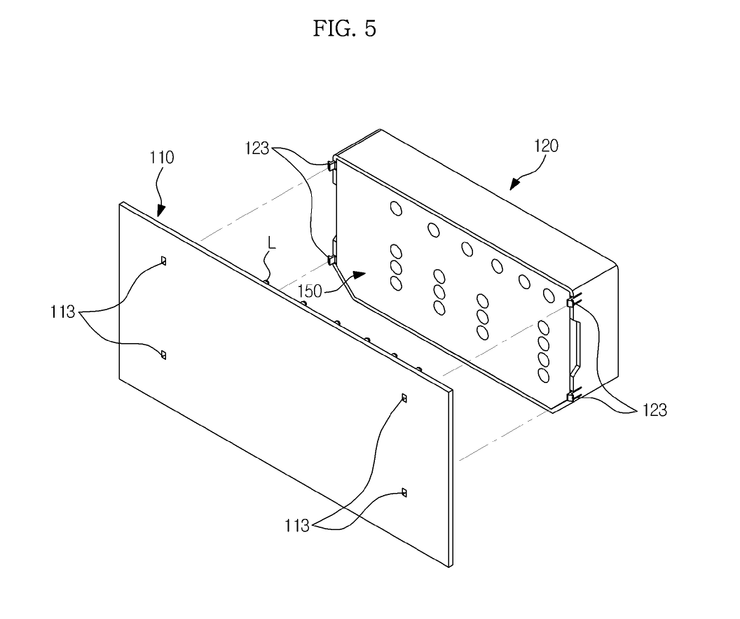

Referring to FIG. 5, the LED guide 150 may be integrally formed with the LED housing 120.

When the LED guide 150 is integrally formed with the LED housing 120, the first projection 127 formed at the LED housing 120 for the coupling of the LED guide 150 and the LED housing 120, the first hook 153 formed at the LED guide 150 and the first coupling groove 111 formed on the PCB 110 are omitted.

When the LED guide 150 is integrally formed with the LED housing 120, the second hook 123 formed at the LED housing 120 is coupled to the second coupling groove 113 formed on the PCB 110, and thus, the LED guide 150 and the LED housing 120 are coupled to the PCB 110.

As shown in FIG. 3, the LED housing 120 forms the exterior while being coupled to the PCB 110. In addition, the LED housing 120 blocks the light emitted from the plurality of LEDs L while being coupled to the PCB 110 to accommodate the plurality of LEDs L, which are assembled to the PCB 110.

The LED housing 120 includes a plurality of LED accommodating portions 121 to accommodate the plurality of LEDs L, the second hook 123 for the coupling with respect to the PCB 110, and a third coupling groove 125 for the coupling with respect to a light diffuser 130 that is to be described later.

As the second hook 123 formed at front portions of the left/right sides of the LED housing 120 is coupled to the second coupling groove 113 formed at the PCB 110, the LED housing 120 is coupled to the PCB 110.

In FIG. 3, it is illustrated that the LED housing 120 is provided at each of the left side and the right side thereof with two units of the second hook 123, but without being limited to such, the second hook 123 may be variously formed in various positions and the number.

According to the position and the number of the second hook 123, the second coupling groove 113 of the PCB 110 to which the second hook 123 is coupled may be variously formed.

The third coupling groove 125 configured for the coupling with the light diffuser 130 is formed on a left side and a right side of a rear surface of the LED housing 120 to correspond to the position and the number of a third hook 133 formed on the light diffuser 130.

By having the third hook 133 formed on the light diffuser 130 coupled to the third coupling groove 125 formed on the LED housing 120, the light diffuser 130 is coupled to the LED housing 120.

In FIG. 3, it is illustrated that the LED housing 120 is provided at each of the left side and the right side of the rear surface thereof with one unit of the third coupling groove 125, to correspond to the third hook 133 formed at each of the left side and the right side of the light diffuser 130, but without being limited to such, the third coupling groove 125 may be variously formed according to the number and the position of the third hook 133 formed at the light diffuser 130.

The light diffuser 130 is coupled to the LED housing 120, and is manufactured with either a transparent or a semi-transparent material such as transparent or a semi-transparent plastic to diffuse the light emitted from the plurality of LEDs L.

By having the light diffuser 130 manufactured with a transparent or a semi-transparent plastic, for example, the manufacturing cost and the manufacturing time of the graphic display 100 is reduced, while the light emitted from the plurality of LEDs L may be effectively diffused.

In order to further effectively diffuse the light emitted from the plurality of L, an upper surface or a lower surface of the light diffuser 130 may be subject to a corrosion treatment or may be added with a texture shape.

The light diffuser 130 includes a plurality of protrusion portions 131 formed at positions corresponding to the plurality of LED accommodating portions 121 formed at the LED housing 120, and the third hook 133 for the coupling with respect to the LED housing 120.

By having the third hook 133 formed at the light diffuser 130 coupled to the third coupling groove 125 formed at the LED housing 120, the light diffuser 130 is coupled to the LED housing 120.

In FIG. 3, it is illustrated that the light diffuser 130 is provided at each of the left side and the right side with one unit of the third hook 133, but without being limited to such, the number and the position of the third hook 133 may be variously formed.

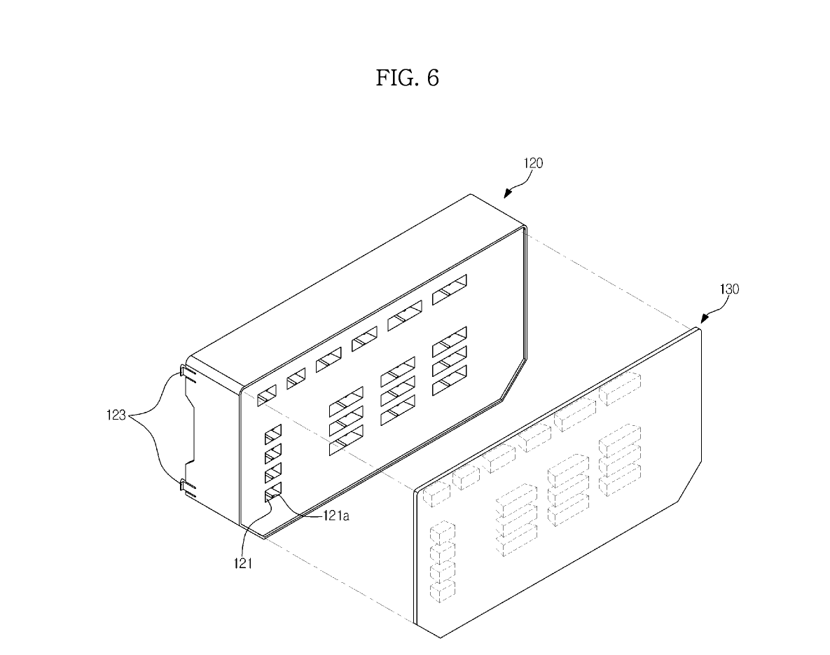

Referring to FIG. 6, if the LED housing 120 is structured in a way that a second projection 121a is formed at each of the LED accommodating portions 121, the third hook 133 of the light diffuser 130 may be omitted.

Since the plurality of the protrusion portions 131 of the light diffuser 130 is coupled to the plurality of the LED accommodating portions 121 in a forcedly fitted manner, the light diffuser 130 is coupled to the LED housing 120.

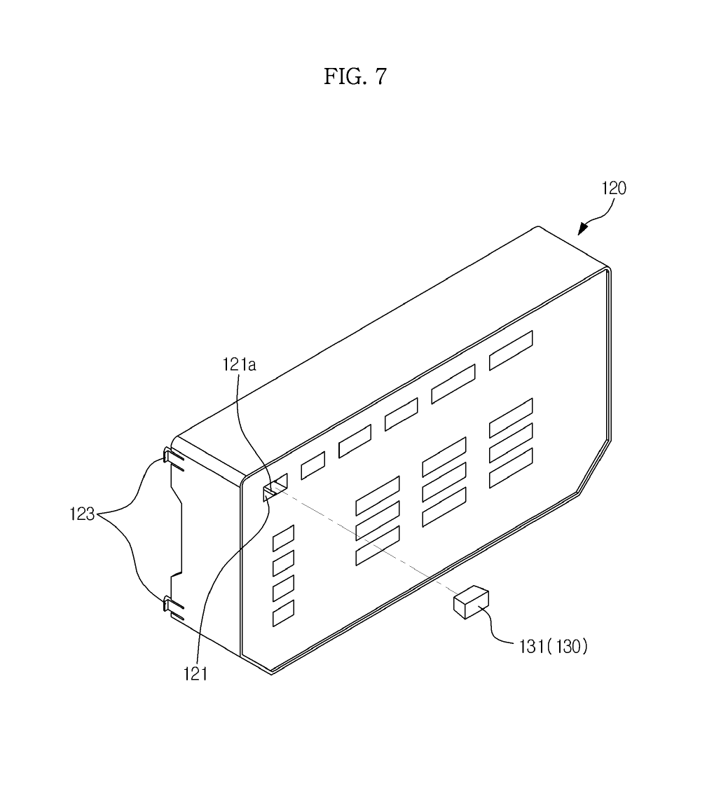

As shown in FIG. 3, the light diffuser 130 is formed as an integral shape to cover the front surface of the LED housing 120. However, as illustrated on FIG. 7, each of the plurality of the protrusion portions 131 may be independently formed to be divided into a plurality of pieces corresponding to the plurality of LEDs.

Since the plurality of the protrusion portions 131 is coupled to the plurality of the LED accommodating portions 121 in a forcedly fitted manner, the light diffuser 130 that is divided into pieces is coupled to the LED housing 120.

The display film 140 is attached to the light diffuser 130, and blocks the light emitted from the plurality of LEDs L.

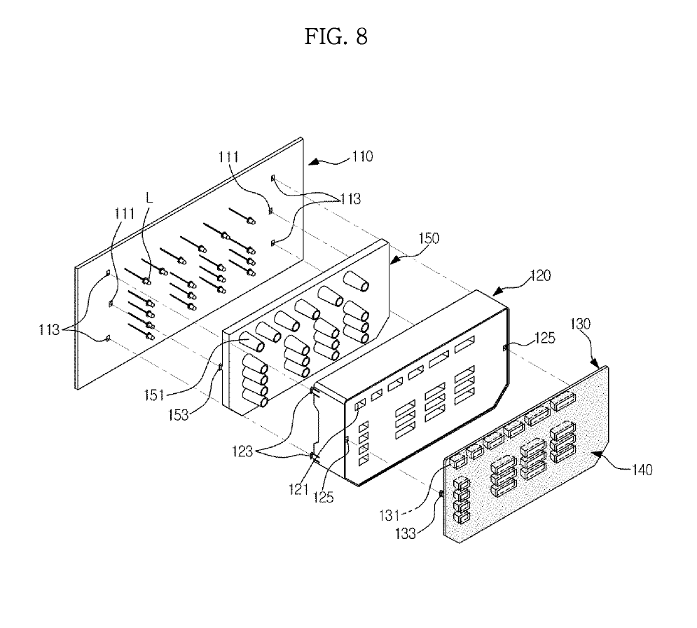

As illustrated on FIG. 3, the display film 140 is separately manufactured from the light diffuser 130, and may be formed to be attached to the light diffuser 130, but as illustrated on FIG. 8, the display film 140 may be formed at the light diffuser 130 in a directly inserted manner.

In addition, although not illustrated on the drawing, the display film 140 may be directly attached to the control panel 90 positioned at an outside the graphic display 100, or inserted into the control panel 90.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A washing machine having a graphic display to display an option selected by a user through light emitted from a plurality of light emitting diodes (LED), the washing machine comprising:
a printed circuit board (PCB) on which the plurality of LEDs are assembled;
a LED housing to form an exterior while coupled to the PCB, and configured to block the light emitted from the plurality of LEDs;
a light diffuser coupled to the LED housing, and formed with transparent material to diffuse the light emitted from the plurality of LEDs; and
a display film attached to the light diffuser to block the light emitted from the plurality of LEDs.

2. The washing machine of claim 1, further comprising:
a LED guide provided with a plurality of LED guide portions formed thereto to guide the plurality of LEDs to maintain a precise position, and configured to block the light emitted from the plurality of LEDs.

3. The washing machine of claim 2, wherein a first hook is formed at the LED guide, and a first coupling groove is formed on the PCB at a position corresponding to a position of the first hook, such that the first hook is coupled to the first coupling groove, and thereby the LED guide is coupled to the PCB.

4. The washing machine of claim 2, wherein a first projection each is formed on a left side surface and a right side surface of an inside the LED housing, such that the LED guide is coupled to the LED housing in a forcedly fitted manner.

5. The washing machine of claim 2, wherein the LED guide is integrally formed with the LED housing.

6. The washing machine of claim 1, wherein a second hook is formed at the LED housing, and a second coupling groove is formed on the PCB at a position corresponding to a position of the second hook, such that the second hook is coupled to the second coupling groove, and thereby the LED housing is coupled to the PCB.

7. The washing machine of claim 1, wherein the LED housing comprises a plurality of LED accommodating portions to accommodate the plurality of LEDs.

8. The washing machine of claim 7, wherein the light diffuser comprises a plurality of protrusion portions formed at positions corresponding to the plurality of LED accommodating portions, and is formed in an integral shape to cover a front surface of the LED housing.

9. The washing machine of claim 8, wherein a third hook is formed at the light diffuser, and a third coupling groove is formed on the LED housing at a position corresponding to a position of the third hook, such that the third hook is coupled to the third coupling groove, and thereby the light diffuser is coupled to the LED housing.

10. The washing machine of claim 8, wherein a second projection is formed at an inside of the plurality of the LED accommodating portions, such that the plurality of protrusion portions is coupled to the second projection formed at an inside of the plurality of the LED accommodating portions in a forcedly fitted manner, and thereby the light diffuser is coupled to the LED housing.

11. The washing machine of claim 7, wherein the light diffuser comprises a plurality of protrusion portions formed at positions corresponding to the plurality of LED accommodating portions, and each of the plurality of protrusion portions is formed independently to each other.

12. The washing machine of claim 1, wherein an upper surface or a lower surface of the light diffuser is subject to a corrosion treatment or added with a texture shape to effectively diffuse the light emitted from the plurality of LEDs.

13. The washing machine of claim 1, wherein the light diffuser includes semi-transparent material.

14. The washing machine of claim 1, wherein the display film is insertedly formed into the light diffuser.

15. A washing machine having a graphic display to display an option selected by a user through light emitted from a plurality of light emitting diodes (LED), the washing machine comprising:
a printed circuit board (PCB) on which the plurality of LEDs are assembled;
a LED guide configured to guide the plurality of LED to maintain a precise position while blocking the light emitted from the plurality of LEDs;
a LED housing to accommodate the plurality of LEDs while blocking the light emitted from the plurality of LEDs;
a light diffuser formed with transparent material or semi-transparent material to diffuse the light emitted from the plurality of LEDs; and
a display film attached to the light diffuser to block the light emitted from the plurality of LEDs,
wherein a second hook is formed at the LED housing, and a second coupling groove is formed on the PCB at a position corresponding to a position of the second hook, such that the second hook is coupled to the second coupling groove, and thereby the LED housing is coupled to the PCB.

16. The washing machine of claim 15, wherein the LED guide comprises a plurality of LED guide portions to guide the plurality of LEDs to maintain a precise position.

17. The washing machine of claim 16, wherein a first hook is formed at the LED guide, and a first coupling groove is formed on the PCB at a position corresponding to a position of the first hook, such that the first hook is coupled to the first coupling groove, and thereby the LED guide is coupled to the PCB.

18. The washing machine of claim 16, wherein a first projection is formed at a left side surface and a right side surface of an inside of the LED housing, such that the LED guide is coupled to the LED housing in a forcedly fitted manner.

19. The washing machine of claim 16, wherein the LED guide is integrally formed with the LED housing.

20. The washing machine of claim 15, wherein the LED housing comprises a plurality of LED accommodating portions to accommodate the plurality of LEDs.

21. The washing machine of claim 20, wherein the light diffuser comprises a plurality of protrusion portions formed at positions corresponding to the plurality of LED accommodating portions, and is formed in an integral shape to cover a front surface of the LED housing.

22. The washing machine of claim 21, wherein a third hook is formed at the light diffuser, and a third coupling groove is formed on the LED housing at a position corresponding to a position of the third hook, such that the third hook is coupled to the third coupling groove, and thereby the light diffuser is coupled to the LED housing.

23. The washing machine of claim 21, wherein a second projection is formed at an inside the LED accommodating portions, such that the plurality of protrusion portions is coupled to the second projection, which is formed at an inside the plurality of the LED accommodating portions, in a forcedly fitted manner, and thereby the light diffuser is coupled to the LED housing.

24. The washing machine of claim 20, wherein the light diffuser comprises a plurality of protrusion portions formed at positions corresponding to the plurality of LED accommodating portions, and each of the plurality of protrusion portions is formed independently to each other.

25. The washing machine of claim 15, wherein an upper surface or a lower surface of the light diffuser is subject to a corrosion treatment, or is added with a texture shape to effectively diffuse the light emitted from the plurality of LEDs.

26. The washing machine of claim 15, wherein the display film is insertedly formed into the light diffuser.

27. The washing machine of claim 1, wherein the transparent material is plastic.

28. The washing machine of claim 15, wherein the transparent material is plastic.

29. The washing machine of claim 15, wherein the semi-transparent material is plastic.

30. The washing machine of claim 2, wherein a first projection each is formed on a top side surface and a bottom side surface of an inside the LED housing, such that the LED guide is coupled to the LED housing in a forcedly fitted manner.

31. The washing machine of claim 16, wherein a first projection is formed at a top side surface and a bottom side surface of an inside of the LED housing, such that the LED guide is coupled to the LED housing in a forcedly fitted manner.

32. A graphic display to display an option selected by a user through light emitted from a plurality of light emitting diodes (LED), the graphic display comprising:
a printed circuit board (PCB) on which the plurality of LEDs are assembled;
a LED housing to form an exterior while coupled to the PCB, and configured to block the light emitted from the plurality of LEDs;
a light diffuser coupled to the LED housing, and formed with transparent plastic to diffuse the light emitted from the plurality of LEDs; and
a display film attached to the light diffuser to block the light emitted from the plurality of LEDs.
